(19) United States
(12) Patent Application Publication
(10) Pub. No.: US 2022/0194519 A1
(43) Pub. Date: Jun. 23, 2022

(54) ELECTRIC BICYCLE

(71) Applicants: SERHII VICTOROVYCH DENYSENKO, Kyivska obl. (UA); Daniel TONKOPIY, Kyivska obl. (UA)

(72) Inventors: SERHII VICTOROVYCH DENYSENKO, Kyivska obl. (UA); Daniel TONKOPIY, Kyivska obl. (UA)

(21) Appl. No.: 17/603,721

(22) PCT Filed: Apr. 21, 2020
(86) PCT No.: PCT/UA2020/000044

§ 371 Date: Oct. 14, 2021

(30) Foreign Application Priority Data
Apr. 15, 2019 (UA) U 2019 03903

(51) Int. Cl. B62M 6/65; B62J 43/13; B62J 43/28; B62K 25/28

(52) U.S. Cl. CPC B62M 6/65; B62J 43/13; B62K 3/02; B62K 25/28; B62J 43/28

(57) ABSTRACT

An electric bicycle has an outer double frame, on which a steering plug with a handlebar and a front wheel with a sleeve is mounted in front of a hinge, and a rear wheel with the sleeve is attached behind. A seat is secured to the outer double frame. An internal double frame is built into the outer double frame, each double frame being a spatial construction of profile tubes rigidly connected by interconnected fastening elements with cutouts into which a battery unit is mounted. The fastening elements are triangular in shape, with at least three of these elements being located in front of the outer double frame, and one element attached to the rear side of the outer double frame. Inside the structure is strengthened by vertical elements in the angle form, with the possibility of horizontal movement. The seat is fixed to the outer double frame on a triangular element. Rear motor-wheel connected to the battery unit secured by the shock absorber element to the outer double frame on one side and a movable pendulum pivotally secured to the outer double frame on the other. The rear motor-wheel is also attached to the controller.

### CROSS REFERENCE TO RELATED APPLICATION

This application is a national stage entry of PCT/UA2020/000044 filed Apr. 21, 2020, under the International Convention claiming priority over Ukraine Patent Application No. u 2019 03903 filed Apr. 15, 2019.

### FIELD OF THE INVENTION

The invention relates to the field of mechanical engineering, in particular to the construction of electric bicycles intended for heavy loads.

### BACKGROUND OF THE INVENTION

The use of classic bicycle frames for electric bicycles with long mileage and high speed is a difficult task. Attempts to use bicycle frames for electric bicycles usually result in the frame being destroyed. The reason for this situation is a completely different sharing of mechanical loads, because the electric vehicle includes a large capacity battery pack as a source of electrical power for an electric motor, unlike a classic bicycle, driven solely by the muscular strength of one person. It should be kept in mind that a high-capacity battery pack typically includes a plurality of battery cells that are electrically connected to each other to form a single unit that is heavy and large. It should also be kept in mind that the construction must ensure that the size of the battery pack cannot be particularly limited because it reduces the capacity of the battery and directly affects the useful mileage on a single charge of the vehicle, and a large mileage in the main characteristic of the product. In addition, the safe operation of an electric bicycle with high-capacity lithium-ion accumulators require reliable mechanical protection of a battery compartment (when mechanically damaged, lithium-ion batteries are extremely flammable), which is impossible to achieve in the classic frame construction, because it requires the protection of the battery, also it must be resistant to mechanical damage and to provide a temperature regime for the most comfortable operation of the battery.

The known construction of the electric moped, containing an outer double frame, which is mounted in front of a steering plug with steering wheel and a front wheel with sleeve, and a rear mounted rear wheel with sleeve, both wheels are rotatable; also on the outer double frame, an internal double frame is built into the outer double frame, with the outer double frame and the inner double frame connected directly and additionally by two rigid cutout fasteners and, in which the motor wheel is mounted between rigid fastening elements, the gear wheel is rigidly secured to the motor wheel, connected by a chain gear with mounted on the rear wheel sleeve, the motor wheel connected via a controller to the battery, and one wheel contains the brake mechanism, and the controller is also connected to the accelerator handle, each double frame is made of two tubes rigidly connected to each other by the connecting structural rigid elements [RU No. 184670, IPC B62K 11/00].

The disadvantage of this construction is the openness of electrical and electronic units adversely affecting the environment. In addition, this construction does not allow you to move with the help of muscle force and therefore, in essence, is not a bicycle. It is also a prerequisite that the area of installation of the block should be located so that the center of gravity of the electric bicycle when pedaling does not rise to an undesirable value, in addition, no frame of ordinary bicycles is meant for the resistance of wheels' axis on twisting, especially, in when using an aluminum frame, when turning the axis with a powerful high-torque electric motor (hereafter a motor-wheel). The motor-wheel rotates the rim, leaning on the axle, that is, the axle of the wheel is used as a point of support, which it then tried to turn the other way. The slots of the frame may not withstand and break, causing the frame to collapse in motion.

Simply strengthening the mechanical structure of a classic bicycle does not produce the desired result. Practical attempts to strengthen the standard frames were unsuccessful. Despite all the improvements, the frame is still destroyed. Both bolts and welded joints are destroyed.

### OBJECT AND SUMMARY OF THE INVENTION

The invention is based on the task of creating an electric bicycle that would have a solid construction, more stable during movement, simplified installation and maintenance.

This problem is solved by the fact that in the electric bicycle containing an outer double frame, on front of which there is mounted the steering plug with a handlebar and the front wheel with the sleeve, and the rear wheel with the sleeve is attached to the rear side of the outer double frame; also a seat is mounted to the outer double frame; the outer double frame has a built in inner double frame, which is the battery compartment, herewith each double frame is a spatial construction of profile tubes rigidly connected by interconnected fastening elements with cutouts; according to the invention, the fastening elements are triangular in shape, with at least three of these elements being in the front side of the outer double frame, and one element is mounted in the rear side of the outer double frame; the inner side of the construction is strengthened with vertical elements in the angle shape, made with the possibility of horizontal movement, herewith the seat is mounted on the outer double frame, namely on the triangle shaped element, and the rear motor-wheel connected to the battery and controller is secured through a shock absorbing element, which from one side is fixed to the outside of the double frame, and on the other—to the moving pendulum pivotally secured to the outer of the double frame.

An electric bicycle contains an electric motor.

A gearbox with sprocket and pedals is mounted at the bottom of the outer double frame, and a rotation sensor is connected to the transmission.

The electric bicycle may additionally include a gas handle, proximity sensors, positioning system, on-board computer and alarm system.

The power elements of the construction perform a dual function. First, they provide adequate rigidity that prevents the outer double frame from shaking and breaking under vertical and horizontal vibrations when moving against loads created by the weight of the battery compartment and the electronic components (including the controller); and secondly, simplify installation and maintenance of the supply system. The box-like construction form also provides adequate air circulation for cooling or heating the elements, the controller, protection against water, snow etc.

The battery compartment is designed as a box-like space frame that protects the battery compartment and control electronics, which are positioned so that the center of gravity of the structure moves down (at the lower point of the construction is placed the battery compartment). Moving down the center of mass of the construction makes the construction of the electric bike more stable during movement. Also, the outer double frame is strengthened with additional elements. Damping rash from the rear shock absorbing element, fixed at one end to the outer double frame and the other to the movable pendulum, is evenly distributed throughout the rear of the outer double frame, preventing the destruction of the points of attachment of the shock absorber element and also compensates the torque of the motor-wheels. The corners of the construction are selected in such a way that the shock absorber elements of the steering plug and the movable pendulum work in synchrony. This avoids excessive loading on the steering plug and its breakage.

### BRIEF DESCRIPTION OF DRAWINGS

FIG. 1 shows an electric bicycle according to an embodiment of the present invention.

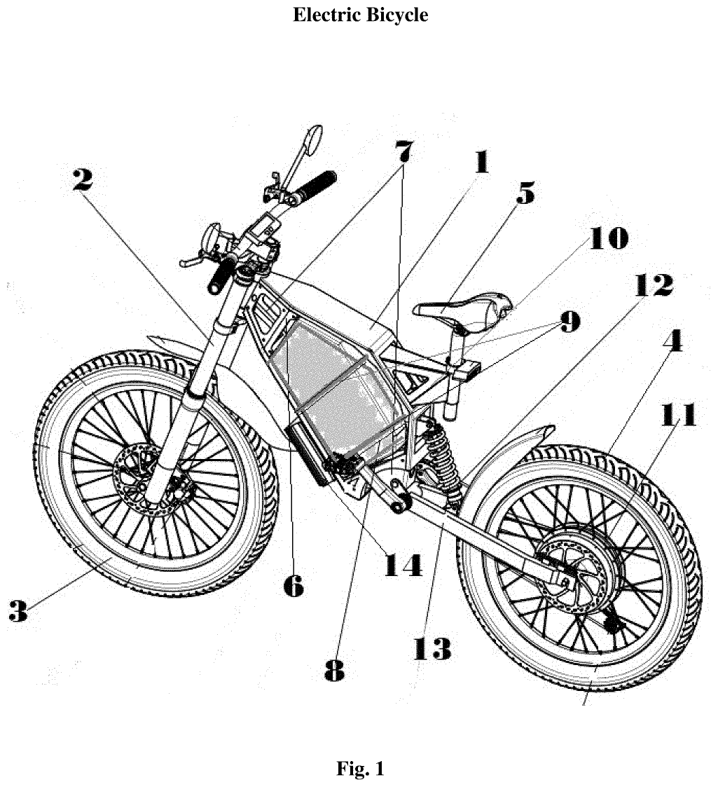

### DETAILED DESCRIPTION OF THE INVENTION

The electric bicycle has the outer (1) double frame, on which the steering plug (2) with the handlebar and the front (3) wheel with the sleeve is mounted in front of the hinge, and the rear (4) wheel with the sleeve is attached behind. The seat (5) is secured to the outer (1) double frame. An internal (6) double frame is built into the outer (1) double frame, each double frame being a spatial construction of profile tubes rigidly connected by interconnected fastening elements (7) with cutouts into which a battery unit (8) is mounted. The fastening elements (7) are triangular in shape, with at least three of these elements being located in front of the outer (1) double frame, and one element attached to the rear side of the outer (1) double frame. Inside the structure is strengthened by vertical elements in the angle form (9), with the possibility of horizontal movement. The seat (5) is fixed to the outer (1) double frame on a triangular element (10). Rear motor-wheel (11) connected to the battery unit (8) secured by the shock absorber element (12) to the outer (1) double frame on one side and a movable pendulum (13) pivotally secured to the outer (1) double frame on the other. The rear motor-wheel (11) is also attached to the controller (14).

The electric bicycle contains an electric motor (not shown). The sprocket and the pedal drivetrain is mounted at the bottom of the outer (1) dual frame, and a rotation sensor (not shown) is connected to the drivetrain.

The electric bicycle may additionally include a gas handle, proximity sensors, positioning system, on-board computer and alarm system (not shown).

Given that the movement of an electric bicycle is provided in full or in part by the motor-wheel (11), which allows to increase the speed and compensate, up to 100% of effort, the basic principle of the electric bicycle is the ability to move with the use of electric traction and without the use of force from the passenger. The electric bike also offers the ability to move on and off pedaling like a normal bicycle, for which the electric bike should be designed and constructed to accommodate the following elements: battery unit (8) with charge control and charge/discharge balance, controller (14), rotary sensor (not shown) and motor (not shown). The electric bicycle can also be equipped with a gas handle, proximity sensors, positioning system, alarm system, on-board computer (not shown). But this equipment is ancillary and does not affect the construction features of the electric bicycle.

The electric bicycle uses the following motion algorithm: when pedaling, the rotation sensor gave a signal to the controller (14) that the motion has started. The controller (14) gives signal the battery unit (8) to supply the necessary power to the motor-wheel (11). The voltage and, accordingly, the power that the motor-wheel (11) develops depends on the speed of pedal rotation. You can also start the movement with the accelerator handle or the gas button. Then the speed and the intensity of the movement will depend on the angle of rotation of the accelerator handle.

1. An electric bicycle comprising:
an outer double frame including a steering plug with a handlebar and a front wheel with a sleeve is mounted in front of a hinge located at the front side of the outer double frame;
a rear wheel with the sleeve is attached to a rear side of the outer double frame;
a seat is secured to the outer double frame;
an internal double frame is built into the outer double frame,
each double frame being a spatial construction of profile tubes rigidly connected by interconnected fastening elements with cutouts;
wherein the fastening elements are triangular in shape, with at least three of these fastening elements being located in the front side of the outer double frame, and one fastening element is attached to the rear side of the outer double frame;
wherein inside the double frame is strengthened by vertical elements in the angle form, with the possibility of horizontal movement;
wherein the seat is fixed to the outer double frame on a triangular element; and
a rear motor-wheel is connected to a battery unit secured by a shock absorber element to the outer double frame on one side and a movable pendulum pivotally secured to the outer double frame on the other.

2. The electric bicycle according to claim 1, further comprising an electric motor.

3. The electric bicycle according to claim 1, further comprising a gearbox with sprocket and pedals mounted at the bottom of the outer double frame, and a rotation sensor connected to the transmission.

4. The electric bicycle according to claim 1, further comprising a gas handle, proximity sensors, positioning system, on-board computer, and alarm system.
